(19) United States
(12) Patent Application Publication
(10) Pub. No.: US 2017/0159945 A1
(43) Pub. Date: Jun. 8, 2017

(54) SOLAR-ASSISTED HEAT STORAGE DEVICE AND SOLAR-ASSISTED WATER SUPPLY SYSTEM COMPRISING THE SAME

(71) Applicant: ZHONGYING CHANGJIANG INTERNATIONAL NEW ENERGY INVESTMENT CO., LTD., Wuhan (CN)

(72) Inventors: Yilong CHEN, Wuhan (CN); Shuchuan HU, Wuhan (CN); Yanfeng ZHANG, Wuhan (CN)

(21) Appl. No.: 15/438,789

(22) Filed: Feb. 22, 2017

Related U.S. Application Data
(63) Continuation-in-part of application No. PCT/CN2015/082768, filed on Jun. 30, 2015.

(30) Foreign Application Priority Data
Aug. 22, 2014 (CN) 201410419863.2

(51) Int. Cl. F24D 17/00; F28D 20/00; F25B 17/08; C09K 5/14; C01B 39/22

(52) U.S. Cl. CPC F24D 17/0063; C09K 5/14; C01B 39/22; F25B 17/08; F28D 20/0056

(57) ABSTRACT

A solar-assisted heat storage device, including at least one molecular sieve heat storage bed and a heat storage water tank. The molecular sieve heat storage bed includes a cylindrical housing and a plurality of heat storage pipes disposed in the housing. The heat storage pipe includes metal pipes having meshes and an adsorbent layer adhered to the surface of the metal pipes. The adsorbent layer includes a molecular sieve adsorbent material adapted to match with water to form a working pair for heat exchange. Two ends of the housing are both configured with sealing valves and respectively connected to an air inlet and an air outlet of an air preheater. One end of the housing is configured with a water inlet connecting to a water outlet of the heat storage water tank, and the other end of the housing is configured with a water outlet.

### CROSS-REFERENCE TO RELATED APPLICATIONS

This application is a continuation-in-part of International Patent Application No. PCT/CN2015/082768 with an international filing date of Jun. 30, 2015, designating the United States, now pending, and further claims priority benefits to Chinese Patent Application No. 201410419863.2 filed Aug. 22, 2014. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

Field of the Invention

The invention relates to a water supply system for a boiler of an electric power plant, and more particularly to a solar-assisted heat storage device and a solar-assisted water supply system comprising the same.

Description of the Related Art

Fossil fuels, including coal, and natural gas, are used as energy sources in many power plants, which contributes to global warming.

Although, solar heating systems may also be used in the power plants, conventional solar heating systems have low heat supply efficiency, limited heat storage capacity, and poor thermal insulation properties. In addition, solar energy supply fluctuates with the Earth's rotation around the sun and also is adversely affected by bad weather.

### SUMMARY OF THE INVENTION

In view of the above-described problems, it is one objective of the invention to provide a solar-assisted heat storage device and a solar-assisted water supply system comprising the same. The solar energy is fully utilized as supplemental to the thermal energy supply of the boiler of the electric power plants, and the normal operation of the boiler is unaffected by the instability and intermittence of the solar energy supply. This significantly decreases the production and operating cost of the electric power plant.

To achieve the above objective, in accordance with one embodiment of the invention, there is provided a solar-assisted heat storage device comprises at least one molecular sieve heat storage bed and a heat storage water tank. The molecular sieve heat storage bed comprises a cylindrical housing and a plurality of heat storage pipes disposed in the housing of the molecular sieve heat storage bed. The heat storage pipe comprises metal pipes having meshes and an adsorbent layer adhered to a surface of each of the metal pipes having meshes for heat storage. An adsorbent material in the adsorbent layer is a molecular sieve adsorbent material adapted to match with water to form a working pair for heat exchange. Two ends of the housing of the heat storage bed are both configured with sealing valves and respectively connected to an air inlet and an air outlet of an air preheater via air pipes. A side of one end of the housing of the heat storage bed is configured with a water inlet for connecting to a water outlet of the heat storage water tank, and a side of the other end of the housing of the heat storage bed is configured with a water outlet for outputting hot water to subsequent equipment.

In a class of this embodiment, the adsorbent layer comprises the molecular sieve adsorbent material and a metal powder having heat conductivity, or the adsorbent layer adopts chemically polymeric adsorbent material.

In a class of this embodiment, the adsorbent material in the adsorbent layer is a silica gel, a natural zeolite, an artificial zeolite, calcium chloride, or a composite adsorbent material.

In a class of this embodiment, the adsorbent material in the adsorbent layer is an artificial 13X zeolite molecular sieve.

In a class of this embodiment, the housing of the heating storage bed comprises double layers of steel plates and a polyurethane insulating layer sandwiched therebetween.

A solar-assisted water supply system comprising the above solar-assisted heat storage device, the system comprising: a condenser, a condensate pump, a shaft sealing heater, multiple stages of primary heaters, a deaerator, and multiple stages of secondary heaters respectively connected to gas outlets of a turbine. A last stage secondary heater is connected to a water inlet of the boiler. Water pipes are configured with valves and water pumps, and air pipes are configured with valves and blower fans. The system further comprises: a medium-temperature solar thermal collector, a secondary solar heater, and the solar-assisted heat storage device.

A water inlet of the medium-temperature solar thermal collector is connected to a water outlet of a shaft sealing heater, and a water outlet of the medium-temperature solar thermal collector is connected to a water inlet of a last stage primary heater.

A water inlet of the secondary solar heater is connected to the water outlet of the medium-temperature solar thermal collector, and a water outlet of the secondary solar heater is connected to the water inlet of the last stage primary heater, a water inlet of a first stage secondary heater, and a water inlet of the air preheater.

A water outlet of the air preheater is connected to the water inlet of the medium-temperature solar thermal collector. A water outlet of the molecular sieve heat storage bed of the solar-assisted heat storage device is connected to the water inlet of a last stage primary heater.

In a class of this embodiment, the medium-temperature solar thermal collector is a vacuum solar thermal collector, a heat-collecting temperature of which exceeds 100° C.

In a class of this embodiment, the secondary solar heater is a chute-type solar thermal collector or a compound parabolic collector (CPC).

In a class of this embodiment, the water outlet of the secondary solar heater is further connected to an absorbing type refrigerator, and a water outlet of the absorbing type refrigerator is connected to the water inlet of the medium-temperature solar thermal collector.

In a class of this embodiment, the absorbing type refrigerator is a lithium bromide refrigerator.

Compared with the prior art, advantages of the solar-assisted heat storage device and the solar-assisted water supply system comprising the same of the invention are summarized as follows:

1) The solar vacuum tube collector is adopted as a primary heating device to prepare hot water having a temperature of no less than 150° C. or steam having a pressure of 0.2 megapascal when the solar irradiation intensity is strong (>600 w/m²), and the hot water or the steam can be directly transported to the primary heater by the water pump to replenish the water for the boiler.

2) The secondary solar heater is used to further improve the water temperature, which is not only energy-saving but also ensures the utilization of the solar energy when the solar irradiation intensity is relatively low. When the solar irradiation intensity is high enough, the secondary solar heater is able to heat the water to the temperature of 150° C. above, and the heated water is then directly introduced to the secondary heater for replenishing the water supply of the boiler.

3) The key device of the system is the molecular sieve heat storage bed, which is the innovative device of the invention. The molecular sieve heat storage bed adopts molecular sieve for heat adsorption and heat storage, has a large heat storage capacity, and is a key device to ensure the successive heat supply of the system. On one hand, the molecular sieve heat storage bed is able to utilize the high temperature water heated by the secondary solar heater to preserve heat quantity of high level, and on the other hand, during nocturnal periods or when the solar irradiation is relatively low, the molecular sieve heat storage bed is able to heat the hot water released from the heat storage water tank to further improve the water temperature, thus ensuring the quality and the succession of the supplied hot water. Besides, the molecular sieve heat storage bed is also advantageous in its great amplitude of temperature increase, large heat storage capacity, good heat preservation performance, and low production cost.

4) In addition to fully utilizing the solar energy, the invention also fully utilizes the exhaust heat of the electric power plant as the condensate from the gas discharge of the power plant serves as the working medium.

5) As the water supplied by the system has a relatively high temperature, it can also be used as the thermal source of the adsorbent refrigerator and therefore provides multi-path of use for the water heating system.

6) The secondary solar heater is adopted to make the water heating system acquire heat quantity of relatively high level, in the meanwhile, the molecular sieve heat storage device is adopted to ensure the continuous operation of the system. Compared with the high-temperature molten salt heat storage system that necessitates great investment and has complex operation procedures, the heat storage device of the invention is much cheap and is advantageous in its large amplitude of temperature increase, large heat storage capacity, and excellent insulating performance, therefore being adaptable to the auxiliary water heating supply system of the boiler of the electric power plant.

### BRIEF DESCRIPTION OF THE DRAWINGS

FIG. 1 is a structure diagram of a solar-assisted water supply system in accordance with one embodiment of the invention;

FIG. 2 is a structure diagram of a molecular sieve heat storage bed of FIG. 1;

FIG. 3 is a cross-sectional view taken from part III-III of FIG. 1;

FIG. 4 is a transverse cross section of a heat storage pipe of FIGS. 2-3; and

FIG. 5 is a diagram illustrating working principle of a system of FIG. 1.

In the drawings, the following numbers are used: 1. Boiler; 2. Turbine; 3. Electric generator; 4. Condenser; 5. Condensate pump; 6. Deaerator; 7. Deaeration water tank; 8-10. Primary heater; 11. Motor-driven feed pump; 12-13. Secondary heater; 14. Shaft sealing heater; 15. Flat solar thermal collector; 16. Compound parabolic collector (CPC); 17. Heat storage water tank; 18. Molecular sieve heat storage bed; 18.1. Housing of heat storage bed; 18.2. Sealing valve; 18.3. Ventilation fan; 18.4. Water adjusting valve; 18.5. Heat storage pipe; 18.5.1. Metal pipe having meshes; 18.5.2. Adsorbent layer; 19. Constant pressure device; 20. Lithium bromide refrigerator; 21. Water pump; 22. Blower fan; and 23. Air preheater.

### DETAILED DESCRIPTION OF THE EMBODIMENTS

Specific embodiments of the invention are described in details combining with the drawings.

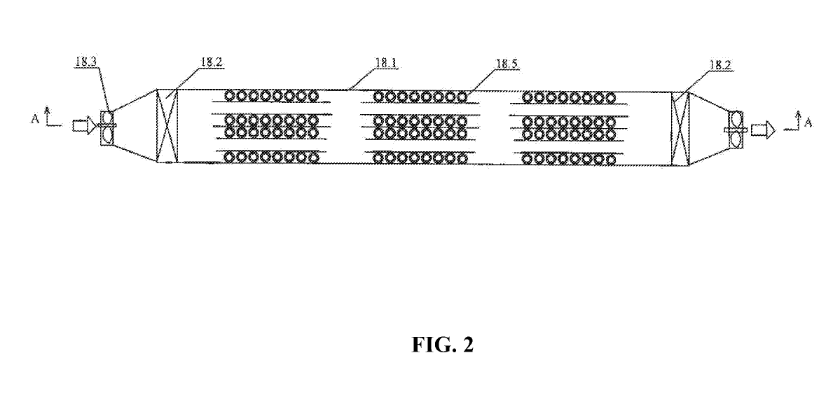

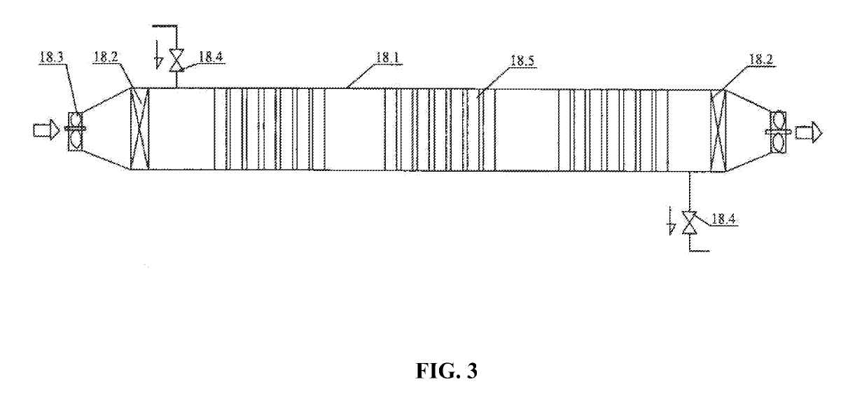

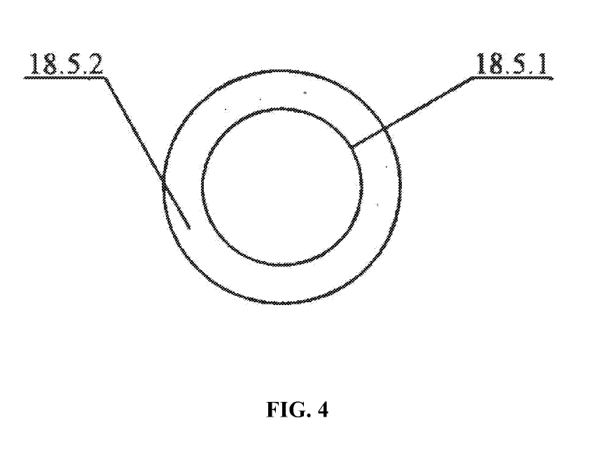

As shown in FIGS. 2-4, a solar-assisted heat storage device comprises at least one molecular sieve heat storage bed and a heat storage water tank 17. The molecular sieve heat storage bed 18 comprises a cylindrical housing 18.1 of the molecular sieve heat storage bed and a plurality of heat storage pipes 18.5 disposed in the housing 18.1 of the molecular sieve heat storage bed. The heat storage pipe 18.5 comprises metal pipes 18.5.1 having meshes and an adsorbent layer 18.5.2 adhered to a surface of each of the metal pipes 18.5.1 having meshes for the purpose of heat storage. An adsorbent material in the adsorbent layer 18.5.2 is a molecular sieve adsorbent material adapted to match with water to form a working pair for heat exchange. Two ends of the housing 18.1 of the heat storage bed are both configured with sealing valves 18.2 and respectively connected to an air inlet and an air outlet of an air preheater 23 via air pipes. A side of one end of the housing 18.1 of the heat storage bed is configured with a water inlet for connecting to a water outlet of the heat storage water tank 17, and a side of the other end of the housing 18.1 of the heat storage bed is configured with a water outlet for outputting hot water to subsequent equipment.

As the solar auxiliary heat storage device just provides water at 150-250° C. for the purpose of saving the fuel for the boiler rather than providing a heat source at 600-800° C. for direct electric power generation, the heat storage device does not need the high temperature molten salt heat storage system that necessitates great investment and has complex operation procedures but adopts a simple low temperature heat storage device. The heat storage device is able to totally meet the demands.

To make the heat preservation easier, the housing 18.1 of the heat storage bed in this embodiment is optionally formed by double layers of steel plates sandwiched with a polyurethane insulating layer having a thickness of approximately 100 mm. The heat storage water tank 17 is optionally made of steel and the insulating layer or made of reinforced concrete structure and the heating insulating layer.

The adsorbent layer 18.5.2 of this embodiment is preferably formed by mixing the adsorbent material with a metal powder having good heat conductivity. The adsorbent material in the adsorbent layer 18.5.2 is preferably a silica gel, a natural zeolite, an artificial zeolite, or a composite adsorbing agent.

The adsorbent layer 18.5.2 of this embodiment is most preferably formed by mixing an artificial 13X zeolite molecular sieve with a metal powder having good heat conductivity and adhering a resulting mixture to the surfaces of the metal pipes 18.5.1 having meshes. It is because the low production cost and strong adsorption capacity that the artificial 13X zeolite molecular sieve is selected as the heat storage material. Generally, the artificial 13X zeolite molecular sieve has a heat storage density of 640 kj/kg and is renewable and recyclable. The heat storage capacity is stable and no heat loss occurs in the absence of extraction. If the chemical polymerization is adopted, a thin layer of highly-heat-conductive substance is covered to a surface of the particle of the adsorbing agent. Thus, a consecutive layer of heat conductive mesh is formed on the surface of the particle of the adsorbing agent by using a small amount of the highly-heat-conductive polymer to improve the heat conductive performance of the particle and to reduce the temperature gradient of the internal heat transfer in the adsorbing agent, thus enhancing heat transfer performance of the adsorbing agent. And such means have been proved to have the minimum influence on the adsorbing capacity of the adsorbing agent. The project preliminarily adopts the electrically conductive polyaniline as the heat conductive working medium, and such a working medium can be directly oxidized and polymerized on the surface of the zeolite particles to make the small amount of the heat conductive polyaniline to form a uniform and consecutive layer of heat conductive mesh, thus significantly improve the conductive coefficient of the adsorbing agent. In the meanwhile, in order to agglomerate the adsorbing agent and the high molecular heat conductive layer covered thereon into a whole, some adhesives are added to the adsorbing agent to adhere the zeolite as a whole in addition to closely tamping the arrangements in the heat storage devices. During the fabricating process, it should be noted that the adsorbing agent must have enough adsorbing channels in avoiding large decrease in the adsorbing capacity of the adsorbing agent. And when selecting the adhesive, the adhesive must be avoided to react with the adsorbing agent.

Working principle of the heat storage device is as follows: when the mechanism stores the heat, water heated by the solar energy is sent to the air preheater 23, a temperature of heated air generally reaches 120-150° C. The heated air is then introduced to the molecular sieve heat storage bed 18 where the heated air is enforced to pass over the heat storage pipe 18.5 and exchanges heat with the adsorbent layer 18.5.2. The artificial zeolite molecular sieve is heated and the water vapor is evaporated. Thus, the heat absorption and storage are realized and the humid air is discharged. After the heat storage, the sealing valves 18.2 at the two ends are closed. When the mechanism discharges heat, the water approximately at 60-70° C. in the heat storage water tank 17 is introduced to the molecular sieve heat storage bed 18, the water fully contacts with the arid artificial zeolite to release heat, so that the water temperature is improved. To match with the volume of the heat storage water tank 17, the size of the molecular sieve heat storage bed 18 must be not too large. Optionally, 4-8 molecular sieve heat storage beds 18 are arranged in parallel to ensure the normal and stable operation of the system.

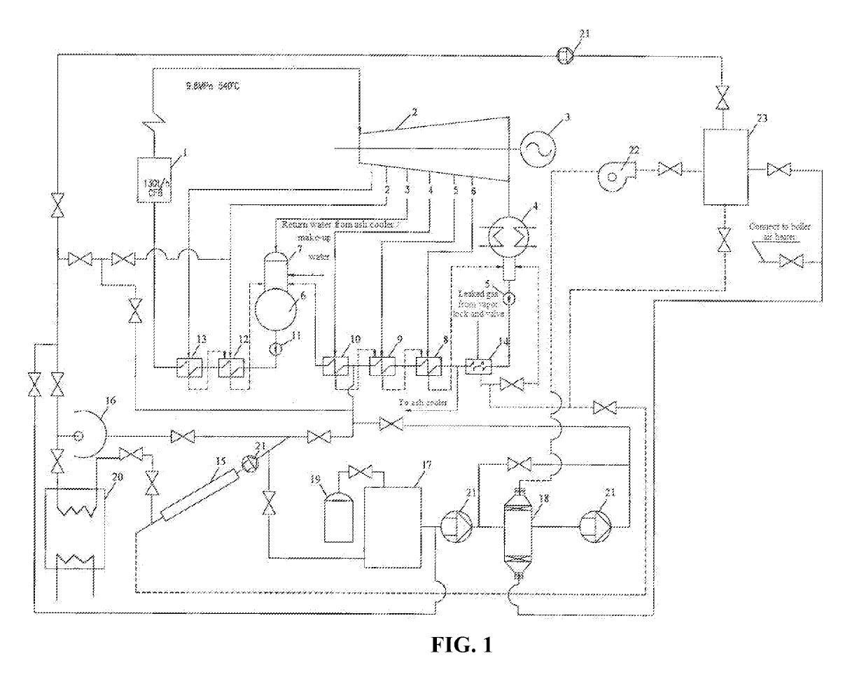

A solar water heating supply system of a boiler of an electric power plant is shown in FIGS. 1-4. The system comprises: a condenser 4, a condensate pump 5, a shaft sealing heater 14, third stage primary heaters 8, 9, 10, a deaerator 6, a deaeration water tank 7, second stage secondary heaters 12, 13 respectively connected to gas outlets of a turbine. A last stage secondary heater 13 is connected to a water inlet of the boiler 1. The system further comprises: a medium-temperature solar thermal collector, a secondary solar heater, and a solar-assisted heat storage device. The primary heaters are low-pressure heaters, and the secondary heaters are high-pressure heaters.

The medium-temperature solar thermal collector adopts a flat solar thermal collector 15. A water inlet of the flat solar thermal collector 15 is connected to a water outlet of the shaft sealing heater 14, and a water outlet of the flat solar thermal collector 15 is connected to a water inlet of a last stage primary heater 10.

The secondary solar heater adopts a compound parabolic collector 16. A water inlet of the compound parabolic collector 16 is connected to a water outlet of the flat solar thermal collector 15, and a water outlet of the compound parabolic collector 16 is connected to the water inlet of the last stage primary heater, a water inlet of a first stage secondary heater 12, and a water inlet of the air preheater 23. A water outlet of the air preheater 23 is connected to the water inlet of the flat solar thermal collector 15.

A water outlet of the molecular sieve heat storage bed 18 of the solar-assisted heat storage device is connected to the water inlet of the last stage primary heater 10. To adapt to the use in nocturnal periods, the design capacity of the heat storage water tank 17 is 8-10 hours of capacity of the boiler 1.

In the meanwhile, to realize different working conditions, water pipes are configured with valves and water pumps 21 on related positions if necessary. And air pipes are configured with valves and blower fans 22.

Working principle of the heat storage device is as follows: when the mechanism stores the heat, water heated by the solar energy is sent to the air preheater 23, a temperature of heated air generally reaches 120-150° C. The heated air is then introduced to the molecular sieve heat storage bed 18 where the heated air is enforced to pass over the heat storage pipe 18.5 and exchanges heat with the adsorbent layer 18.5.2. The artificial zeolite molecular sieve is heated and the water vapor is evaporated. Thus, the heat absorption and storage are realized and the humid air is discharged. After the heat storage, the sealing valves 18.2 at the two ends are closed. When the mechanism discharges heat, the water approximately at 60-70° C. in the heat storage water tank 17 is introduced to the molecular sieve heat storage bed 18, the water fully contacts with the arid artificial zeolite to release heat, so that the water temperature is improved. To match with the volume of the heat storage water tank 17, the size of the molecular sieve heat storage bed 18 must be not too large. Optionally, 4-8 molecular sieve heat storage beds 18 are arranged in parallel to ensure the normal and stable operation of the system.

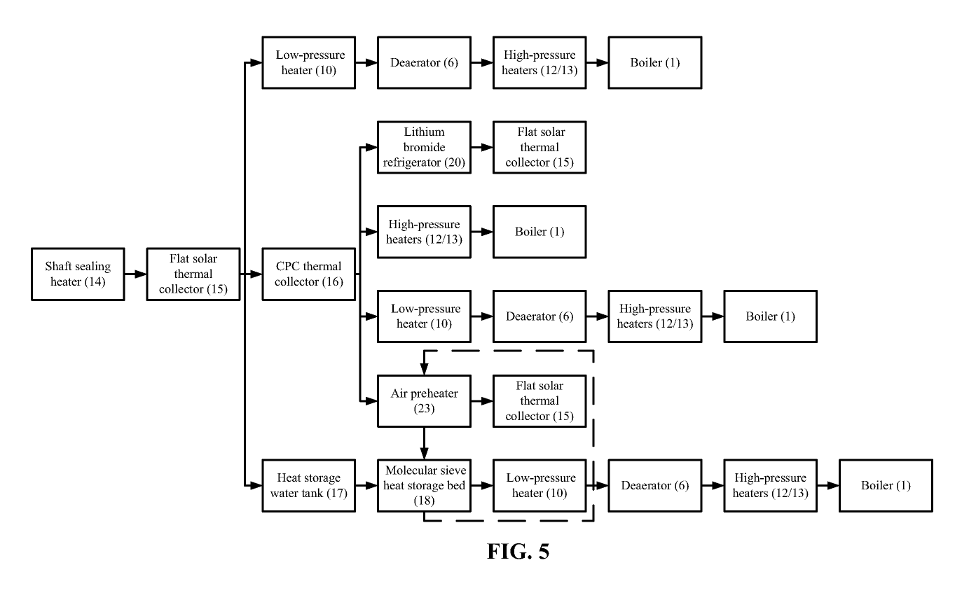

Working principle of the invention is shown in FIGS. 1-5. Condensate is extracted from the shaft sealing heater 14 of the electric power plant as an operating working medium of the hot water supply system and is transported to the flat solar thermal collector 15 via the water pump 21. In diurnal periods when the solar irradiation intensity is strong enough (>600 w/m²), the solar energy is absorbed to heat the water to a temperature of 150° C. The heated water is output in three paths as follows:

1) The heated water is directly introduced to the primary heater 10 and then to the deaerator 6. Deaerated water passes through the high pressure heaters 12, 13 to the boiler 1.

2) The heated water enters the heat storage water tank 17 for storage. During nocturnal periods when the solar energy cannot be gathered, the heated water is extracted from the heat storage water tank 17 to the molecular sieve heat storage bed 18 by the water pump 21 for secondary heating to make a water temperature 150° C. above. Thereafter the heated water is sent to the primary heater 10 and then to the deaerator 6. Deaerated water respectively passes through the secondary heaters 12, 13 to the boiler 1. Thus, the solar energy was utilized in the nocturnal periods or other conditions in the absence of the solar energy.

3) The heated water is introduced to the compound parabolic collector 16 by the water pump for secondary heating, and the heated water is used in four respects: 3.1) when a water temperature at the water outlet of the compound parabolic collector 16 is higher than 250° C., the heated water is directly introduced to the secondary heaters 12, 13 where the water is heated and then sent to the boiler 1; 3.2) the heated water is sent to an absorbing type refrigerator as a heat source for refrigeration, the heated water at the outlet end is then sent back to a water inlet of the flat solar thermal collector 15 for recycling; 3.3) when the solar irradiation is weak and the water temperature at the water outlet of the compound parabolic collector 16 may be lower than 200° C., the discharged water is sent to the primary heater 10 and then to the deaerator 6 for deaeration; and the deaerated water respectively passes through the secondary heaters 12, 13 and reaches the boiler 1; and 3.4) the heated water is sent to the air preheater 23 to heat the low temperature humid air in the c 18. The energy stored in the adsorbent layer 18.5.2 is utilized, and the discharged water from the air preheater 23 is returned to the flat solar thermal collector 15.

The working conditions in the above is switchable according to practical conditions.

The key of the invention lies in the solar water heating and supplying system formed by the medium-temperature solar heater, the secondary solar heater, the air heater, deaeration water tank, the molecular sieve heat storage bed 18, and the absorbing type refrigerator mechanism is able to continuously supply water at 60-250° C. to the electric power plant when being connected to the water feeding system of the boiler of the electric power plant. The solar water heating and supplying system fully utilizes the solar energy as the supplemental fuel for the boiler of the electric power plant, and the normal operation of the boiler is not affected by the instability and intermittence of the solar energy, thus the production cost of the electric power plant is significantly reduced. The key device of the system is the molecular sieve heat storage bed 18, which make the system continuously provide heat quantity of high level. Thus, the protection scope of the invention is not limited by the above described embodiments. It will be obvious to those skilled in the art that changes and modifications may be made without departing from the invention in its broader aspects, for example, the number and the arrangements of the heat storage pipe 18.5 of the molecular sieve heat storage bed 18 are not limited to the specific modes in the above embodiments, as long as the two ends of the molecular sieve heat storage bed allow the air to pass through and the two sides thereof allow the water to pass through and the heat storage requirements are satisfied. For another example, the use of the artificial zeolite as the adsorbent material in the adsorbent layer 18.5.2 is a preferred embodiment, while the use of the active carbon or silica gel as the heat storage materials are also able to realize the technical scheme of the invention. For still another example, the secondary solar heater can not only adopt the compound parabolic collector 16 but also other middle/high-temperature thermal collector including the chute type solar thermal collectors. Therefore, the aim in the appended claims is to cover all such changes and modifications as fall within the true spirit and scope of the invention.

The invention claimed is:

1. A solar-assisted heat storage device, comprising:
at least one molecular sieve heat storage bed; and
a heat storage water tank comprising a water outlet; wherein
the at least one molecular sieve heat storage bed comprises a cylindrical housing and a plurality of heat storage pipes disposed in the housing of the molecular sieve heat storage bed;
the heat storage pipe comprises metal pipes having meshes and an adsorbent layer adhered to a surface of the metal pipes having meshes;
the adsorbent layer comprises a molecular sieve adsorbent material adapted to match with water to form a working pair for heat exchange; two ends of the housing of the heat storage bed are both configured with sealing valves and respectively connected to an air inlet and an air outlet of an air preheater via air pipes; and
one end of the housing of the heat storage bed is configured with a water inlet connecting to the water outlet of the heat storage water tank, and the other end of the housing of the heat storage bed is configured with a water outlet.

2. The device of claim 1, wherein the adsorbent layer comprises the molecular sieve adsorbent material and a metal powder having heat conductivity, or the adsorbent layer adopts chemically polymeric adsorbent material.

3. The device of claim 1, wherein the adsorbent material in the adsorbent layer is a silica gel, a natural zeolite, an artificial zeolite, calcium chloride, or a composite adsorbent material.

4. The device of claim 2, wherein the adsorbent material in the adsorbent layer is a silica gel, a natural zeolite, an artificial zeolite, calcium chloride, or a composite adsorbent material.

5. The device of claim 3, wherein the adsorbent material in the adsorbent layer is an artificial 13X zeolite molecular sieve.

6. The device of claim 4, wherein the adsorbent material in the adsorbent layer is an artificial 13X zeolite molecular sieve.

7. The device of claim 1, wherein the housing of the heating storage bed comprises double layers of steel plates and a polyurethane insulating layer sandwiched therebetween.

8. The device of claim 2, wherein the housing of the heating storage bed comprises double layers of steel plates and a polyurethane insulating layer sandwiched therebetween.

9. A solar-assisted water supply system, comprising: a condenser, a condensate pump, a shaft sealing heater, multiple stages of primary heaters, a deaerator, and multiple stages of secondary heaters connected to one another in that order and respectively connected to gas outlets of a turbine; wherein
the system further comprises: a medium-temperature solar thermal collector, a secondary solar heater, and a solar-assisted heat storage device of claim 1;
a last stage secondary heater of the multiple stages of secondary heaters is connected to a water inlet of a boiler; and water pipes are configured with valves and water pumps, and air pipes are configured with valves and blower fans;
a water inlet of the medium-temperature solar thermal collector is connected to a water outlet of the shaft sealing heater, and a water outlet of the medium-temperature solar thermal collector is connected to a water inlet of a last stage primary heater;
a water inlet of the secondary solar heater is connected to the water outlet of the medium-temperature solar thermal collector, and a water outlet of the secondary solar heater is connected to the water inlet of the last stage primary heater, a water inlet of a first stage secondary heater), and a water inlet of the air preheater; a water outlet of the air preheater is connected to the water inlet of the medium-temperature solar thermal collector; and
a water outlet of the molecular sieve heat storage bed of the solar-assisted heat storage device is connected to the water inlet of a last stage primary heater.

10. The system of claim 9, wherein the medium-temperature solar thermal collector is a vacuum solar thermal collector, a heat-collecting temperature of which exceeds 100° C.

11. The system of claim 9, wherein the secondary solar heater is a chute-type solar thermal collector or a compound parabolic collector (CPC).

12. The system of claim 9, wherein the water outlet of the secondary solar heater is further connected to an absorbing type refrigerator, and a water outlet of the absorbing type refrigerator is connected to the water inlet of the medium-temperature solar thermal collector.

13. The system of claim 10, wherein the water outlet of the secondary solar heater is further connected to an absorbing type refrigerator, and a water outlet of the absorbing type refrigerator is connected to the water inlet of the medium-temperature solar thermal collector.

14. The system of claim 11, wherein the water outlet of the secondary solar heater is further connected to an absorbing type refrigerator, and a water outlet of the absorbing type refrigerator is connected to the water inlet of the medium-temperature solar thermal collector.

15. The system of claim 12, wherein the absorbing type refrigerator is a lithium bromide refrigerator.

16. The system of claim 13, wherein the absorbing type refrigerator is a lithium bromide refrigerator.

17. The system of claim 14, wherein the absorbing type refrigerator is a lithium bromide refrigerator.
